(19) United States
(12) Patent Application Publication
(10) Pub. No.: US 2025/0134277 A1
(43) Pub. Date: May 1, 2025

(54) SEAT COVER FIXING STRUCTURE

(71) Applicant: TOYOTA BOSHOKU KABUSHIKI KAISHA, Aichi-ken (JP)

(72) Inventor: Hiroaki NATSUME, Toyota-shi (JP)

(73) Assignee: TOYOTA BOSHOKU KABUSHIKI KAISHA, Aichi-ken (JP)

(21) Appl. No.: 18/921,544

(22) Filed: Oct. 21, 2024

(30) Foreign Application Priority Data
Oct. 27, 2023 (JP) 2023-184734

(51) Int. Cl. A47C 31/11; B60N 2/58

(52) U.S. Cl. CPC A47C 31/11; B60N 2/5816

(57) ABSTRACT

There is provided a seat cover fixing structure for fixing a cover end of a seat cover to a pad back surface of a seat pad. The seat cover fixing structure includes: a planar cover side surface member that forms a retracting portion to be retracted along the pad back surface of the cover end; and a planar pad side surface member including a sewn portion that is to be sewn to a back surface member integrally molded along the pad back surface of the seat pad to form a free end portion that allows to be partially rolled up, and a fixing portion that is provided at the free end portion and is configured to fix the cover side surface member against tension caused by retracting the cover side surface member.

### CROSS-REFERENCE TO RELATED APPLICATIONS

This application is based on and claims priority under 35 USC 119 from Japanese Patent Application No. 2023-184734 filed on Oct. 27, 2023, the contents of which are incorporated herein by reference.

### TECHNICAL FIELD

The present disclosure relates to a seat cover fixing structure. Specifically, the present disclosure relates to a seat cover fixing structure for fixing a cover end of a seat cover to a pad back surface of a seat pad.

### BACKGROUND ART

JP2021-041011A discloses a structure in which a cover end of a seat cover is retracted to and fixed to a back side of a seat pad. Specifically, the seat cover is fixed to the pad back surface of the seat pad by pressing and coupling a female hook-and-loop fastener sewn to the end of the seat cover to a male hook-and-loop fastener integrally molded with the pad back surface of the seat pad.

### SUMMARY OF INVENTION

In the related art described above, a flat surface must be provided on a pad back surface of the seat pad for attaching a hook-and-loop fastener, which tends to impair the degree of freedom of design. The present disclosure provides a seat cover fixing structure capable of fixing a cover end of a seat cover to a seat pad while ensuring a degree of freedom of a pad shape.

A seat cover fixing structure of the present disclosure is configured as follows, for example.

According to an illustrative aspect of the present disclosure, a seat cover fixing structure for fixing a cover end of a seat cover to a pad back surface of a seat pad includes: a planar cover side surface member that forms a retracting portion to be retracted along the pad back surface of the cover end; and a planar pad side surface member including a sewn portion that is to be sewn to a back surface member integrally molded along the pad back surface of the seat pad to form a free end portion that allows to be partially rolled up, and a fixing portion that is provided at the free end portion and is configured to fix the cover side surface member against tension caused by retracting the cover side surface member.

According to the above aspect, by sewing the pad side surface member capable of fixing the cover end to the back surface member of the seat pad in a manner of forming the free end portion that allows to be partially rolled up, an attachment space required for the back surface member of the pad side surface member can be reduced. As a result, the cover end of the seat cover can be appropriately fixed to the pad back surface of the seat pad while appropriately ensuring the degree of freedom of the pad shape of the seat pad.

According to another illustrative aspect of the present disclosure, the fixing portion is a through hole formed in the pad side surface member to penetrate the pad side surface member in a direction orthogonal to a surface direction of the pad side surface member. A fixed portion of the cover side surface member that is to be fixed to the through hole is a hooking portion to be fixed to the through hole against the tension by being hooked to the through hole.

According to the above aspect, by forming the fixing portion provided in the pad side surface member as the through hole, even if a foamed resin material flows around the through hole due to integral molding with the seat pad, the through hole can be made to function appropriately by simply removing a portion blocking the through hole after molding. That is, unlike a configuration such as a hook-and-loop fastener in which the function is likely to be impaired by the foamed resin material flowing around, the fixing portion can be configured to be less likely to be damaged by integral molding.

According to another illustrative aspect of the present disclosure, the through hole has a slit shape that extends to become elongated in a direction in which the tension acts in a state where the hooking portion is fixed. The hooking portion has a rod shape that extends to become elongated in a direction orthogonal to the direction in which the tension acts in a state where the hooking portion is fixed to the through hole, and has a maximum diameter of a cross section that is shorter than a hole length of the through hole and a rod length longer than the hole length.

According to the above aspect, the rod-shaped hooking portion can be easily inserted into the slit-shaped through hole by passing the cross section having the maximum diameter shorter than the hole length in a longitudinal direction. In addition, after the hooking portion is inserted into the through hole, the rod-shaped hooking portion is provided in the pad side surface member in a manner of extending in the direction orthogonal to the through hole which extends in the direction in which the tension acts, thereby making it difficult for the hooking portion to come out of the through hole.

According to another illustrative aspect of the present disclosure, the sewn portion of the pad side surface member is sewn to the back surface member such that a sew line extends in a direction orthogonal to the direction in which the tension acts.

According to the above aspect, the pad side surface member can be provided in a manner of being capable of exhibiting high tensile strength with respect to the back surface member.

### BRIEF DESCRIPTION OF DRAWINGS

FIG. 1 is a perspective view illustrating a schematic configuration of a seat cover fixing structure according to a first embodiment;

FIG. 2 is a perspective view illustrating a state before a cover side surface member is fixed to a pad side surface member;

FIG. 3 is a perspective view illustrating a state in which the cover side surface member is fixed to the pad side surface member; and

FIG. 4 is a bottom view of FIG. 3.

### DESCRIPTION OF EMBODIMENTS

Hereinafter, an embodiment of the present disclosure will be described with reference to the drawings.

### First Embodiment

### (Schematic Configuration of Seat Cover Fixing Structure 1)

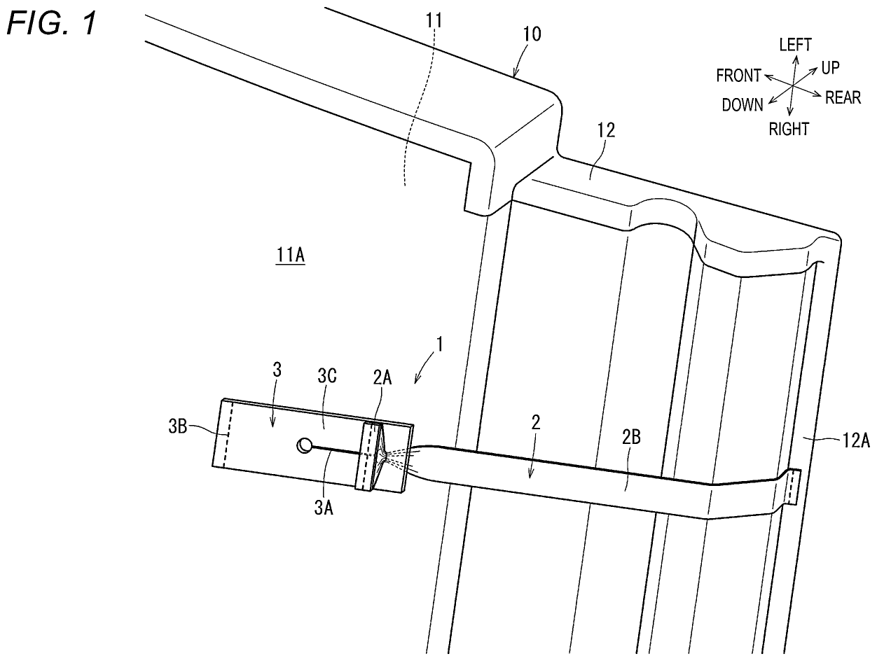

First, a configuration of a seat cover fixing structure 1 according to a first embodiment of the present disclosure will be described with reference to FIGS. 1 to 4. In the following description, when a direction such as front, rear, up, down, left, or right is described, it is assumed that the direction indicates a corresponding direction illustrated in the drawings. In addition, in the following description, when a specific reference diagram is not described or when there is no corresponding reference numeral in the reference diagram, any one of FIGS. 1 to 4 is referred to as appropriate.

As illustrated in FIG. 1, the seat cover fixing structure 1 according to the present embodiment is applied to a seat cushion 10 that forms a seating portion of an automobile seat. FIG. 1 is a perspective view illustrating a part of the seat cushion 10 in an enlarged manner from a seat back side. The seat cushion 10 includes a seat frame (not illustrated) that forms a framework thereof, a seat pad 11 that covers the seat frame from above, and a seat cover 12 that covers the seat pad 11 from a pad front surface side.

The seat pad 11 is formed of a polyurethane foam molded body. The seat pad 11 is implemented in a manner that a back surface member 11A made of a nonwoven fabric is integrally molded along a pad back surface of the seat pad 11. The back surface member 11A is set in a mold of the seat pad 11, and is molded in a manner of being integrally bonded along the pad back surface of the seat pad 11 by foam molding a foamed resin material of the seat pad 11 in the mold.

The seat cover 12 is formed of a planar fabric member. The seat cover 12 covers the seat pad 11 from the pad front surface side. Each of the front, rear, left, and right peripheral edge portions of the seat cover 12 is retracted to and fixed to a pad back side of the seat pad 11. Accordingly, the seat cover 12 is stretched widely over the pad front surface of the seat pad 11.

In addition, during being retracted, the seat cover 12 winds the seat frame (not illustrated) that supports the seat pad 11 from back, and presses the seat pad 11 against the seat frame. Accordingly, during being retracted, the seat cover 12 fixes the seat pad 11 to the seat frame.

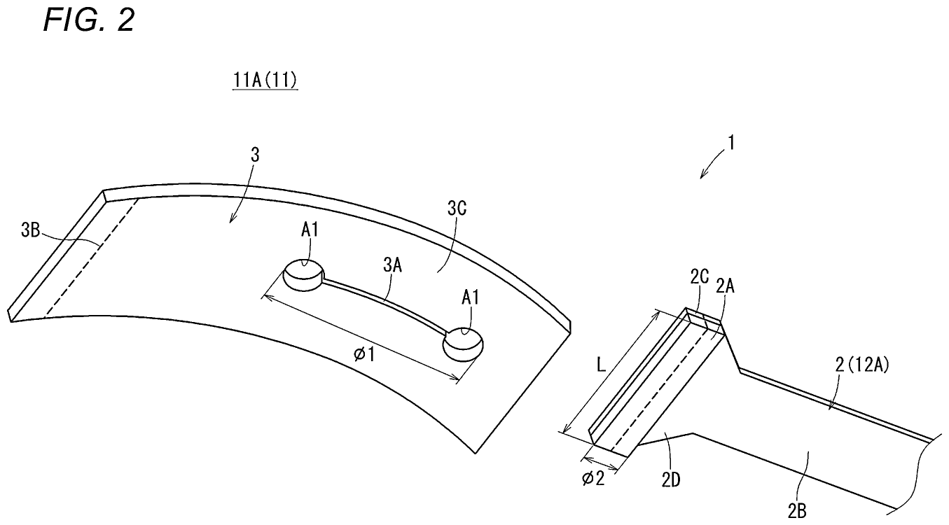

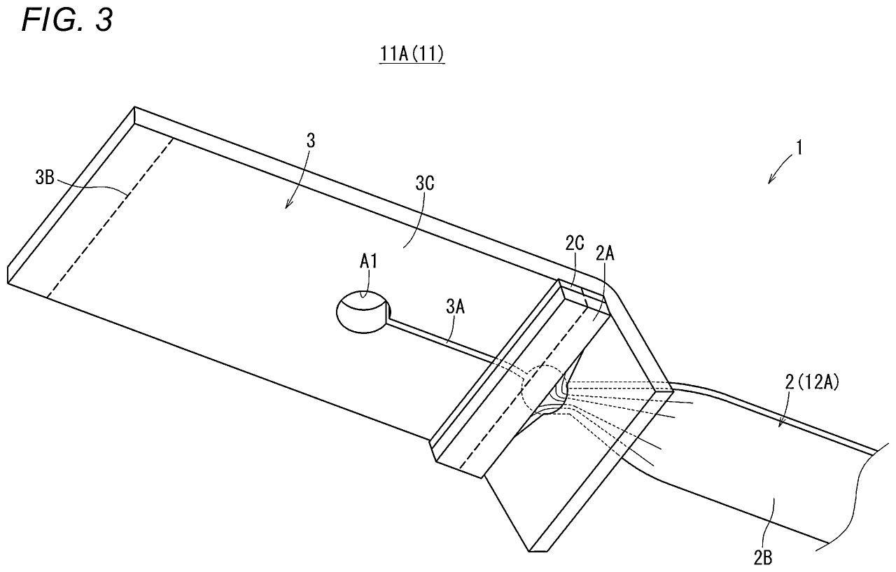

Among the peripheral edge portions of the seat cover 12, a cover end 12A of a part of the peripheral edge portion on the rear side of the seat cover 12 is retracted from the rear side to the front side along the pad back surface of the seat pad 11, and is fixed to the back surface member 11A of the pad back surface by the seat cover fixing structure 1. As illustrated in FIGS. 2 and 3, the seat cover fixing structure 1 includes a strip-shaped cover side surface member 2 that is sewn to the cover end 12A and is to be retracted along the pad back surface, and a reed-shaped pad side surface member 3 that is sewn to the back surface member 11A of the seat pad 11 and to which the cover side surface member 2 is to be fixed.

As illustrated in FIG. 2, the cover side surface member 2 includes a flat rod-shaped resin plate 2A sewn to a tip end portion in a strip length direction which is a retracting direction, the resin plate 2A extending in an elongated manner in a direction orthogonal to the strip length direction. As illustrated in FIG. 3, the resin plate 2A functions as a hooking portion which is inserted into and hooked to a through hole 3A formed in the pad side surface member 3. Here, the resin plate 2A corresponds to the “fixed portion” and the “hooking portion” of the present disclosure. The through hole 3A corresponds to the “fixing portion” of the present disclosure.

As illustrated in FIG. 2, the cover side surface member 2 is formed of a single strip-shaped member. Specifically, the cover side surface member 2 includes a retracting strip portion 2B that extends in the strip length direction from a portion sewn with the cover end 12A with a substantially constant strip width, and a plate attachment portion 2C that widens the strip width at a tip end portion of the retracting strip portion 2B in the strip length direction. The plate attachment portion 2C widens the strip width in a trapezoidal shape via an expanded diameter portion 2D that diagonally widens the strip width from the retracting strip portion 2B.

The resin plate 2A is sewn to the plate attachment portion 2C. The resin plate 2A has a rod length L substantially equal to the strip width of the plate attachment portion 2C. The resin plate 2A is sewn to the plate attachment portion 2C over substantially the entire region in the strip width direction. The resin plate 2A has a flat rod shape with a rectangular cross section.

The resin plate 2A is sewn in a manner that a side surface forming a long side of the cross section is brought into contact with the plate attachment portion 2C of the cover side surface member 2. A maximum diameter φ2 (that is, a length of the long side in the cross section) of the cross section of the resin plate 2A is shorter than a hole length φ1 of the through hole 3A of the pad side surface member 3.

In the pad side surface member 3, the slit-shaped through hole 3A that extends in an elongated manner in the strip length direction is formed in a center of the reed in the strip width direction. The through hole 3A is formed in an intermediate portion of the pad side surface member 3 in the strip length direction, leaving both ends uncovered. At both ends of the through hole 3A, round extension holes A1 are formed to prevent breakage caused by stress concentration.

One end portion of the pad side surface member 3 in the strip length direction is sewn to the back surface member 11A of the seat pad 11 (a sewn portion 3B). The sewn portion 3B is sewn over the entire region of the pad side surface member 3 in the strip width direction in a manner that a sew line extends in the strip width direction. Accordingly, the pad side surface member 3 can be bent in a manner that a portion extending in the strip length direction from the sewn portion 3B serves as a free end portion 3C and is rolled up from the back surface member 11A. The through hole 3A is formed in the free end portion 3C away from the sewn portion 3B. The free end portion 3C extends rearward from the sewn portion 3B, that is, in a direction from which the cover side surface member 2 is retracted.

The pad side surface member 3 is sewn to the back surface member 11A at a stage before the back surface member 11A is integrally molded with the seat pad 11. The pad side surface member 3 is set together with the back surface member 11A in a mold for the seat pad 11 and is integrally molded with the seat pad 11. At this time, since the pad side surface member 3 is sewn to a surface of the back surface member 11A opposite to a surface integrally molded with the seat pad 11, the foamed resin material is basically less likely to flow around.

Specifically, the pad side surface member 3 is sewn to the back surface member 11A not at an edge thereof but at an intermediate portion away from the edge thereof, and thus the foamed resin material is basically less likely to flow around. However, even if the foamed resin material flows around and blocks the through hole 3A during molding, the pad side surface member 3 is implemented in a manner that the portion blocking the through hole 3A can be easily removed after molding.

That is, as compared with a structure such as a hook-and-loop fastener which is prone to clogging with a foamed resin material, since a functional portion for fixing the cover side surface member 2 is the through hole 3A, the pad side surface member 3 can be easily used only by removing the portion blocking the through hole 3A after molding. Accordingly, integral molding with the seat pad 11 can be easily performed without providing a separate member such as masking for preventing the foamed resin material from flowing around.

The pad side surface member 3 is formed of a planar member made of polyester canvas. Accordingly, even when the pad side surface member 3 is heated during integral molding with the seat pad 11, thermal deformation such as bending hardly occurs. Therefore, even when the pad side surface member 3 is subjected to integral molding with the seat pad 11, it is possible to appropriately maintain a state in which the pad side surface member 3 is sewn in a manner of extending along the back surface member 11A.

The cover side surface member 2 is fixed to the pad side surface member 3 by inserting the resin plate 2A into the through hole 3A as follows. As illustrated in FIG. 2, first, the pad side surface member 3 is rolled up from the back surface member 11A to separate the through hole 3A from the back surface member 11A. Next, the resin plate 2A is inserted into the through hole 3A from a back side of the pad side surface member 3, that is, from a side facing the back surface member 11A, while the cover side surface member 2 is retracted toward the pad side surface member 3 in the strip length direction.

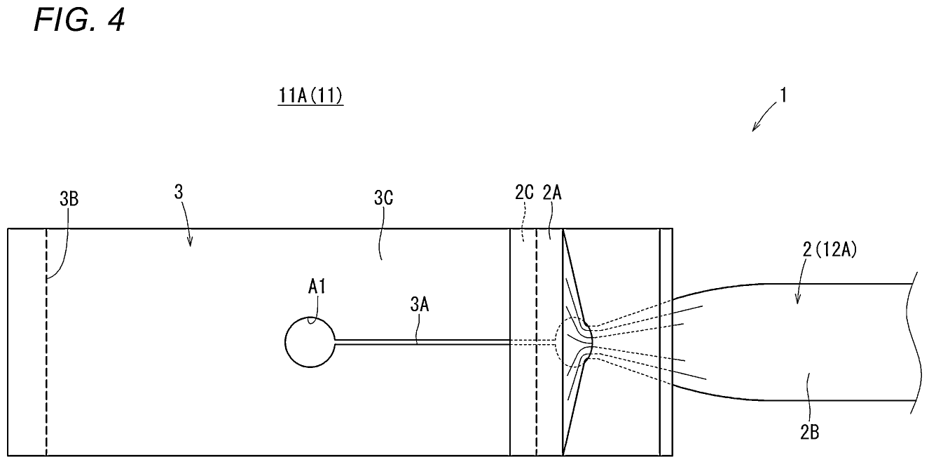

Specifically, first, the resin plate 2A is twisted vertically so as to pass through the through hole 3A in a longitudinal direction. Next, the resin plate 2A together with the plate attachment portion 2C is inserted into the through hole 3A. Accordingly, as illustrated in FIGS. 3 and 4, the resin plate 2A is returned to a horizontal state by a restoring force of the plate attachment portion 2C at a position where the resin plate 2A is inserted into the through hole 3A.

Then, a retracting force applied to the cover side surface member 2 is released. Accordingly, due to an action of tension against the retraction of the cover side surface member 2, the resin plate 2A is hooked in a manner of abutting on a front surface of the pad side surface member 3 without coming out of the through hole 3A. As a result of hooking, the cover side surface member 2 is fixed to the pad side surface member 3 against the tension caused by the retraction.

The resin plate 2A is inserted into the through hole 3A from the back side of the pad side surface member 3, that is, from the side facing the back surface member 11A.

Accordingly, the resin plate 2A is inserted into the front side of the pad side surface member 3, that is, into a side not facing the back surface member 11A (a side visible from the outside). Therefore, an operator can appropriately visually check whether the resin plate 2A is appropriately inserted into the through hole 3A. As compared with a case in which the resin plate 2A is inserted into the back side of the back surface member 11A, since the resin plate 2A is positioned at a side where the resin plate 2A is easily to see and grasp by hand, an operation of removing the resin plate 2A from the through hole 3A can be easily performed.

The resin plate 2A has the rod length L longer than the hole length φ1 of the slit-shaped through hole 3A. Therefore, after the resin plate 2A is inserted into the through hole 3A, it is difficult for the resin plate 2A to come out of the through hole 3A, not only when the resin plate 2A is oriented orthogonal to the direction in which the through hole 3A extends, but also when the resin plate 2A is turned in a manner that the resin plate 2A extends in the same direction as the direction in which the through hole 3A extends. That is, the resin plate 2A is easily to be inserted into the through hole 3A and difficult to be removed therefrom.

In summary, the seat cover fixing structure 1 according to the present embodiment has the following configuration. In the following description, reference numerals assigned in parentheses correspond to the configurations described in the embodiment described above.

That is, a seat cover fixing structure (1) for fixing a cover end (12A) of a seat cover (12) to a pad back surface of a seat pad (11), the seat cover fixing structure (1) including: a planar cover side surface member (2) that forms a retracting portion to be retracted along the pad back surface of the cover end (12A); and a planar pad side surface member (3) including a sewn portion (3B) that is to be sewn to a back surface member (11A) integrally molded along the pad back surface of the seat pad (11) in a manner of forming a free end portion (3C) that allows to be partially rolled up, and a fixing portion (3A) that is provided at the free end portion (3C) and is configured to fix the cover side surface member (2) against tension caused by retraction.

In this way, by sewing the pad side surface member (3) capable of fixing the cover end (12A) to the back surface member (11A) of the seat pad (11) in a manner of forming the free end portion (3C) that allows to be partially rolled up, an attachment space required for the back surface member (11A) of the pad side surface member (3) can be reduced. As a result, the cover end (12A) of the seat cover (12) can be appropriately fixed to the pad back surface of the seat pad (11) while appropriately ensuring the degree of freedom of the pad shape of the seat pad (11).

The fixing portion (3A) is a through hole (3A) formed in the pad side surface member (3) in a manner of penetrating the pad side surface member (3) in a direction orthogonal to the surface of the pad side surface member (3). A fixed portion (2A) of the cover side surface member (2) that is to be fixed to the through hole (3A) is a hooking portion (2A) to be fixed to the through hole (3A) against the tension by being hooked to the through hole (3A).

In this way, by forming the fixing portion (3A) provided in the pad side surface member (3) as the through hole (3A), even if the foamed resin material flows around the through hole (3A) due to integral molding with the seat pad (11), the through hole (3A) can be made to function appropriately by simply removing the portion blocking the through hole (3A) after molding. That is, unlike a configuration such as a hook-and-loop fastener in which the function is likely to be impaired by the foamed resin material flowing around, the fixing portion (3A) can be configured to be less likely to be damaged by integral molding.

The through hole (3A) has a slit shape that extends in an elongated manner in a direction which the tension acts in a state in which the hooking portion (2A) is fixed. The hooking portion (2A) has a rod shape that extends in an elongated manner in a direction orthogonal to the direction in which the tension acts in a state in which the hooking portion (2A) is fixed to the through hole (3A), and has a maximum diameter (42) of a cross section that is shorter than a hole length (φ1) of the through hole (3A) and a rod length (L) longer than the hole length (φ1).

According to the above configuration, the rod-shaped hooking portion (2A) can be easily inserted into the slit-shaped through hole (3A) by passing the cross section having the maximum diameter (φ2) shorter than the hole length (φ1) in the longitudinal direction. In addition, after the hooking portion (2A) is inserted into the through hole (3A), the rod-shaped hooking portion (2A) is provided in the pad side surface member (3) in a manner of extending in the direction orthogonal to the through hole (3A) which extends in the direction in which the tension acts, thereby making it difficult for the hooking portion (2A) to come out of the through hole (3A).

The sewn portion (3B) of the pad side surface member (3) is sewn to the back surface member (11A) in a manner that a sew line extends in a direction orthogonal to a direction in which the tension acts. According to the above configuration, the pad side surface member (3) can be provided in a manner of being capable of exhibiting high tensile strength with respect to the back surface member (11A).

The hooking portion (2A) is provided a tip end portion of the cover side surface member (2) in a direction of retracting the cover side surface member (2).

The hooking portion (2A) is a resin plate.

The sewn portion (3B) is located at a part separated away from a part of retracting the cover side surface member (2) beyond the free end portion (3C) in a longitudinal direction of the pad side surface member (3).

The sewn portion (3B) of the pad side surface member (3) is provided on a surface of the back surface member (11A) opposite to a surface integrally molded with the seat pad (11).

In a state where the hooking portion (2A) is fixed, the pad side surface member (3) is disposed between the hooking portion (2A) and the back surface member (11A), or the hooking portion (2A) is disposed between the pad side surface member (3) and the back surface member (11A).

The through hole (3A) formed in the slit shape has both ends to which an extension hole (A1) is each formed.

### Other Embodiments

Although the embodiment of the present disclosure has been described above with reference to one embodiment, the present disclosure can be implemented in various embodiments other than the above embodiment.
1. In addition to a seat provided for a vehicle other than an automobile, such as trains, the seat cover fixing structure according to the present disclosure may be applied to a seat provided for a vehicle other than an automobile, such as aircraft and ships. In addition to seats provided for vehicles, the seat cover fixing structure may be applied to seats provided in various facilities such as sports facilities, theaters, concert halls, and event venues, or massage seats. Moreover, the seat cover fixing structure may be applied to a seat back in addition to the seat cushion.
2. The cover side surface member, that is, the surface member forming the retracting portion to be retracted along the pad back surface of the cover end may be a surface member sewn to the cover end, or may be formed of the cover end itself. The cover side surface member and the pad side surface member may be formed of surface members made of polyester canvas, carpet materials, other fabric materials, or leather materials. The cover side surface member and the pad side surface member may be made of the same material or different materials.
3. The combination of the fixing portion provided in the pad side surface member and the fixed portion provided in the cover side surface member is not limited to a specific combination. For example, the cover side surface member may be provided with the through hole (the fixing portion), and the pad side surface member may be provided with the hooking portion (the fixed portion) that is to be hooked to the through hole against tension by being hooked to the through hole. In addition to the rod-shaped member such as the resin plate shown in the above embodiment, the hooking portion may be a hooking button such as a round button to be hooked to the through hole by being inserted into the through hole, or a hooking tool such as a J-hook of which a hook portion at a tip end is to be hooked to the through hole.

The combination of the fixing portion and the fixed portion is not limited to the combination of the through hole and the hooking portion, and may be a combination of a male hook-and-loop fastener and a female hook-and-loop fastener. The through hole is not limited to a slit-shaped hole, and may be a combination hole in which a large-diameter hole for passing the hooking portion and a small-diameter hole through for hooking the hooking portion are aligned.
4. The sewn portion sewn to the back surface member of the pad side surface member may be any sewn portion as long as the sewn portion is sewn to the back surface member in a manner of forming a free end portion that allows to be partially rolled up, and may be sewn along one side of the pad side surface member, or may be sewn along two or three adjacent sides. As long as the sewn portion is sewn in a manner of forming a free end portion that allows to be partially rolled up, the sew line does not have to be in a shape that opens with an end, and may be in a shape that closes in an endless manner (a loop shape). Further, not limited to the edge of the pad side surface member, the sewn portion may be sewn to the back surface member at an intermediate portion away from the edge.

The free end portion of the pad side surface member is provided in a manner of extending in the direction from which the cover side surface member is retracted from the sewn portion, whereas the free end portion may be provided in a manner of extending in a direction opposite to the direction from which the cover side surface member is retracted. The free end portion of the pad side surface member may extend in other directions, and for example, when the fixing portion is a slit-shaped through hole, the pad side surface member may be twisted in a direction in which the through hole extends in an elongated manner in the direction in which the tension acts, with the sewn portion as a fulcrum, by the tension caused by the hooking portion of the cover side surface member being hooked to the through hole.

What is claimed is:

1. A seat cover fixing structure for fixing a cover end of a seat cover to a pad back surface of a seat pad, the seat cover fixing structure comprising:
a planar cover side surface member that has a retracting portion to be retracted along the pad back surface of the cover end; and
a planar pad side surface member including a sewn portion that is to be sewn to a back surface member integrally molded along the pad back surface of the seat pad to form a free end portion that allows to be partially rolled up, and a fixing portion that is provided at the free end portion and is configured to fix the cover side surface member against tension caused by retracting the cover side surface member.

2. The seat cover fixing structure according to claim 1, wherein
the fixing portion has a through hole formed in the pad side surface member to penetrate the pad side surface member in a direction orthogonal to a surface direction of the pad side surface member, and
a fixed portion provided in the cover side surface member is a hooking portion to be fixed to the through hole against the tension by being hooked to the through hole.

3. The seat cover fixing structure according to claim 2, wherein
the through hole has a slit shape that extends to become elongated in a direction in which the tension acts in a state where the hooking portion is fixed, and
the hooking portion has a rod shape that extends to become elongated in a direction orthogonal to the direction in which the tension acts in a state where the hooking portion is fixed to the through hole, and has a maximum diameter of a cross section that is shorter than a hole length of the through hole and a rod length longer than the hole length.

4. The seat cover fixing structure according to claim 1, wherein
the sewn portion is a portion in which the pad side surface member is sewn to the back surface member such that a sew line of the sewn portion extends in a direction orthogonal to the direction in which the tension acts.

5. The seat cover fixing structure according to claim 2, wherein
the hooking portion is provided a tip end portion of the cover side surface member in a direction of retracting the cover side surface member.

6. The seat cover fixing structure according to claim 2, wherein
the hooking portion is a resin plate.

7. The seat cover fixing structure according to claim 1, wherein
the sewn portion is located at a part separated away from a part of retracting the cover side surface member beyond the free end portion in a longitudinal direction of the pad side surface member.

8. The seat cover fixing structure according to claim 1, wherein
the sewn portion of the pad side surface member is provided on a surface of the back surface member opposite to a surface integrally molded with the seat pad.

9. The seat cover fixing structure according to claim 2, wherein
in a state where the hooking portion is fixed, the pad side surface member is disposed between the hooking portion and the back surface member, or the hooking portion is disposed between the pad side surface member and the back surface member.

10. The seat cover fixing structure according to claim 3, wherein
the through hole formed in the slit shape has both ends to which an extension hole is each formed.
